(19) United States
(12) Patent Application Publication
(10) Pub. No.: US 2012/0184258 A1
(43) Pub. Date: Jul. 19, 2012

(54) Hierarchical Device type Recognition, Caching Control & Enhanced CDN communication in a Wireless Mobile Network

(75) Inventors: Surya Kumar Kovvali, Westborough, MA (US); Charles Boyle, Upton, MA (US); Ravi Valmikam, Westford, MA (US); Krishnan Ramakrishnan, Hopkinton, MA (US)

(73) Assignee: MOVIK NETWORKS, Littleton, MA (US)

(21) Appl. No.: 13/183,777

(22) Filed: Jul. 15, 2011

Related U.S. Application Data
(60) Provisional application No. 61/364,560, filed on Jul. 15, 2010.

(51) Int. Cl. H04W 4/18

(52) U.S. Cl. 455/418

(57) ABSTRACT

The present disclosure describes an apparatus and method for recognizing the mobile device type by information monitored from multiple means, such as by transparently monitoring Control Plane protocols, and monitoring user plane protocols (for example user agent header in HTTP protocols), and using such information for controlling data-caching operations, selectively delivering content, and selecting alternative interfaces/networks when available. Additionally, the invention discloses methods to propagate the learned information through header enrichment to external devices, such as content servers or CDN devices. The apparatus and methods are applicable to an application/content-aware caching device in a wireless mobile network that operates as an inline transparent device intercepting control plane and user plane protocols.

This application claims priority of U.S. Provisional Patent Application 61/364,560, filed Jul. 15, 2010, the disclosure of which is incorporated herein by reference in its entirety.

### BACKGROUND OF THE INVENTION

Content caching devices or web-caches that cache frequently viewed web pages, pictures and multi-media content are deployed in the internet for reducing transport latencies, and reducing download times for frequently accessed content across the internet. Similarly, web-proxies/caches are also deployed at enterprise sites to cache frequently used Internet web-content within the enterprise network.

Caching devices 10 can also be used in mobile wireless network, for example, a 3G/UMTS network 20. The wireless network includes a Radio Access Network (RAN) 21 and a Core Network (CN) 22. A typical wireless network is shown in FIG. 1.

The GGSN 3 (Gateway GPRS Service Node) connects the mobile wireless network to the IP Core Network. The Gateway GPRS Support Node (GGSN) 3 is a main component of the GPRS (General Packet Radio Service) network. The GGSN 3 is responsible for compatibility between the GPRS network and external packet switched networks, such as the Internet 1 and X.25 networks.

When viewed from an external network, the GGSN 3 appears as a router to a sub-network, because the GGSN 3 hides the GPRS infrastructure from the external network. When the GGSN 3 receives data addressed to a specific user, it checks if the user is active. If it is, the GGSN 3 forwards the data to the SGSN 4 serving the mobile user. However if the mobile user is inactive, the data are discarded, or a paging procedure is initiated to locate and notify the mobile device. For data originated within the GPRS network, the GGSN 3 routes these mobile-originated packets to the correct external network.

The GGSN 3 converts the GPRS packets coming from the SGSN 4 into the appropriate packet data protocol (PDP) format (e.g., IP or X.25) and sends them out on the corresponding packet data network. For incoming packets, the PDP addresses are converted to the GSM address of the destination user. The readdressed packets are then sent to the responsible SGSN 4. In order to accomplish this function, the GGSN 3 stores the current SGSN address of the user and its associated profile in its location register. The GGSN 3 is responsible for IP address assignment and is the default router for the connected user equipment (UE) 7. The GGSN 3 also performs authentication functions.

A Serving GPRS Support Node (SGSN) 4 is responsible for the delivery of data packets from and to the mobile stations within its geographical service area. Its tasks include packet routing and transfer, mobility management (attach/detach and location management), logical link management, and authentication and charging functions. The location register of the SGSN 4 stores location information and user profiles of all GPRS users registered with this SGSN 4.

The Radio Network Controller (or RNC) 5 is a governing element in the radio access network and is responsible for controlling the Node Bs 6 that are connected to it. The RNC 5 carries out radio resource management, some of the mobility management functions and is the point where encryption is done before user data is sent to and from the mobile. The RNC 5 connects to the SGSN (Serving GPRS Support Node) 4 in the Packet Switched Core Network.

Node B 6 is a term used to denote the base transceiver station (BTS) in the UMTS/3GPP Architecture. As in all cellular systems, such as GSM, Node B (or BTS) 6 contains radio frequency transmitter(s) and the receiver(s) used to communicate directly with the user equipment, which move freely around it.

The user equipment (UE) 7 comprises all user equipment, including handsets, smart phones and computing equipment.

Radio Access Networks (RANs), such as in GSM/GPRS, 3G/UMTS/HSDPA/HSUPA, LTE, CDMA network etc., have their own private networks (PLMN) and interconnect to the Internet/IP networks through gateway devices (GGSN in GSM/GPRS, 3G/UMTS/HSDPA/HSUPA, and PDSN in CDMA). Content caches 10 are typically deployed outside of the RAN as shown in FIG. 1. However, content caches 10 are not deployed in the RAN between the Wireless Base Station 6 and GGSN 3 or PDSN (in a CDMA Network).

One reason for this is, while the user application payloads are TCP/IP, those payloads are embedded within Radio Access Network Protocols that are specific to the specific RAN. Thus, within the RAN, application payloads are not directly visible for performing content-aware caching and other optimizations. The RAN network 20 is deployed as a transport network that transports user IP traffic (Bearer IP traffic) using either ATM or IP transports. Regardless of the type of transport, the RAN network transports the user payloads in per user/per service tunnels. Such tunnels are terminated within the PDSN or GGSN 3, which forwards the bearer IP traffic to the public IP network using IP forwarding rules. Thus in the prior art deployments, the RAN network is content un-aware.

Mobile operators maintain and charge subscribers based on content usage (for example, based on bytes downloaded per month), and maintain usage quotas per plan periods (per day, week, month etc.). Such charging policies also include pre-paid charging, post paid-charging etc. Such accounting and charging is typically done at the interface between the mobile network and public network, for example in the GGSN 3 as shown in FIG. 1, the PDSN in a CDMA embodiment, or another device used for accounting purposes (i.e. an Accounting Device).

Co-pending Patent Publication No. 2010/0034089, entitled “Content Caching in the Radio Access Network”, filed Aug. 6, 2009, the contents of which are incorporated by reference, proposes deploying Content Aware Ran Caches in the Radio Access Network at one or more locations.

FIG. 2 shows a current 3G network topology. The figure shows the devices as described above, with reference to FIG. 1. In addition, the interfaces between devices are identified. Specifically, the NodeB 6 and RNC 5 communicate using the IuB interface. Similarly, the RNC 5 and SGSN 4 utilize a IuPS interface, while the SGSN 4 and the GGSN 3 utilize the Gn interface. The GGSN 3 interfaces to the internet 1 using Gi interface. Co-pending U.S Patent Publication No. 2010/0034089 details that the RAN Cache may be placed in numerous locations within RAN.

However, it would be beneficial if there were additional features that may be implemented using a cache in the RAN.

### SUMMARY OF THE INVENTION

The current invention identifies methods and procedures for classifying devices by mapping device categories, managing the caches as multiple classes (termed “colored caches” where each color maps to a set of device types), optimizing delivery for certain device classes (for example, iPhones or Droid smartphones) to improve the mobile user's Quality Of Experience (QOE).

Another aspect of the current invention uses the locally derived device class and content type information to select the interface/network domain, and/or local CDN device (Content Delivery Network Device) when the deployment configuration has multiple core network interfaces as shown in FIGS. 3-6.

A third aspect of the current invention is to add information learned from interpreting specific UE's control plane, user plane protocols and service plane interactions with operator network devices, such as HLR, PCRF, RADIUS, and SPR, using header enrichment (for example, through additional headers in HTTP requests), while forwarding the selected requests to locally connected CDN devices, or to other external devices through the traffic offload interface, or by re-encapsulating the user requests along with additional headers into the associated user plane protocol and then forwarding to the Core Network.

Additionally, many web-sites re-direct mobile client requests for top page requests to different content (for example to WAP pages), when they recognize the requesting device is a feature phone or smart-phone with a smaller screen-size etc, so that the page being loaded is more readable from mobile handsets. Many websites make the top pages of the site as non-cacheable (so that transit devices do not cache and serve the pages from cache), and redirect the requests to WAP-content-gateway when they recognize the request is from a mobile handset. For making the content cache-friendly so that caching device could cache and serve the correct content (for example WAP-content-gateway for feature phones, and regular pages for full PCs, and smart phones), some web-sites use “vary” and user agent headers, indicating that this content should be served by an intermediate cache only if the User Agent header in the client http-request matches with the user agent header when the response was sent by the web-site. Some web sites do not mark the top page as non-cacheable, and also do not use the “vary header” in the http response as an indication to the transit cache. However, they send a HTTP-Response with a Status code indicating redirect to client request when they recognize the request is from a mobile handset. Therefore, this type of web-site sends different page content to a full featured device (such as laptop computer), as compared to a mobile handset (due to re-directing to WAP-Content-gateway). Furthermore, the response headers do not indicate that the data should not be cached, and the data is not marked with a “vary-header”. In this scenario, it will be unknown to the transit cache to which client requests this cached content should be served, and to which client requests it should be re-directed to WAP-content-gateway. The current invention proposes that the caching device identify such sites that have these characteristics (i.e. sites that cause redirects to WAP-content-gateway, mark the content as cacheable, but do not use vary-header with user agent field), and to explicitly mark the page in local cache to denote that the data should only be served for certain client device types only.

### BRIEF DESCRIPTION OF THE DRAWINGS

FIG. 1 illustrates a wireless network;

FIG. 2 represents the major components of a 3G RAN;

FIG. 3 represents the placement of a RAN cache in a first location in a 3G network;

FIG. 4 represents the placement of a RAN cache in a second location in a 3G network;

FIG. 5 represents the placement of a RAN cache in a third location in a 3G network;

FIG. 6 represents the placement of a RAN cache in a LTE network;

FIG. 7A is a flowchart detailing the determination of device class for a user equipment using information from the control plane;

FIG. 7B is a flowchart detailing the determination of device class for a user equipment using user plane information;

FIG. 7C is a flowchart detailing actions that can be taken based on device class; and

FIG. 8 is a representative block diagram of a RAN cache.

### DETAILED DESCRIPTION OF THE INVENTION

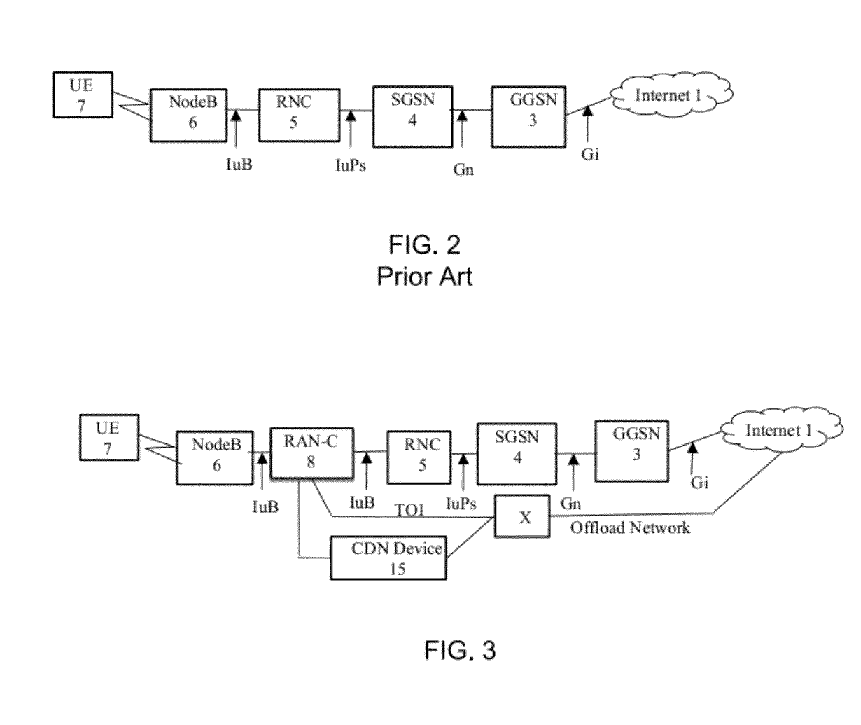

FIGS. 2-5 show the network elements in the 3G/UMTS Network, and alternative placement locations for the RAN-C device 8 that implements methods and procedures of the current invention.

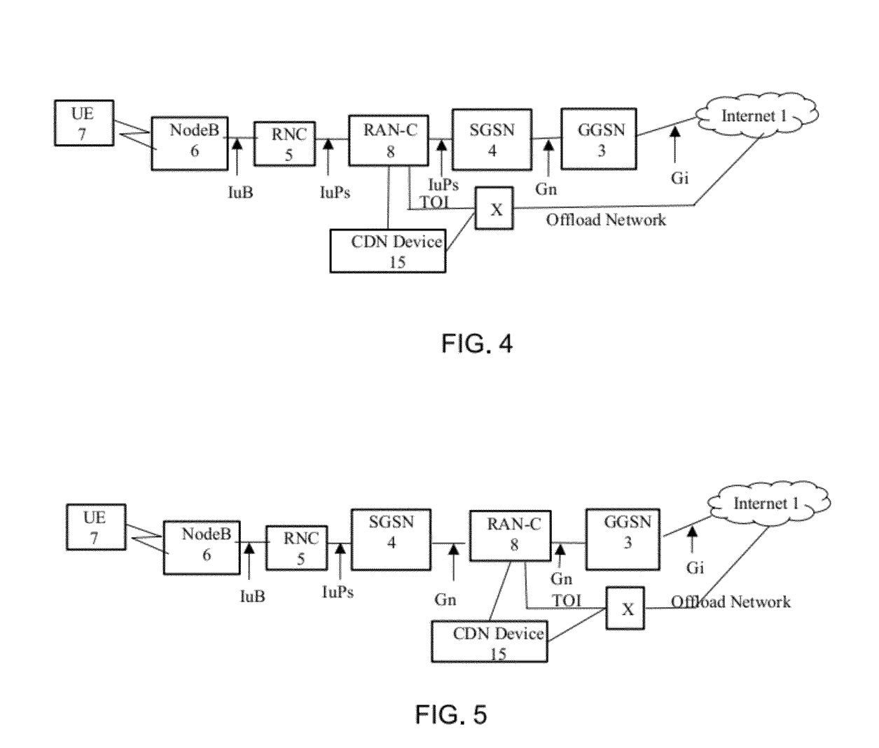

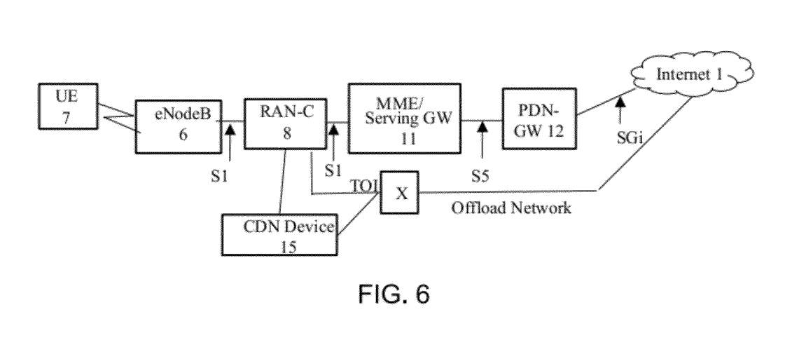

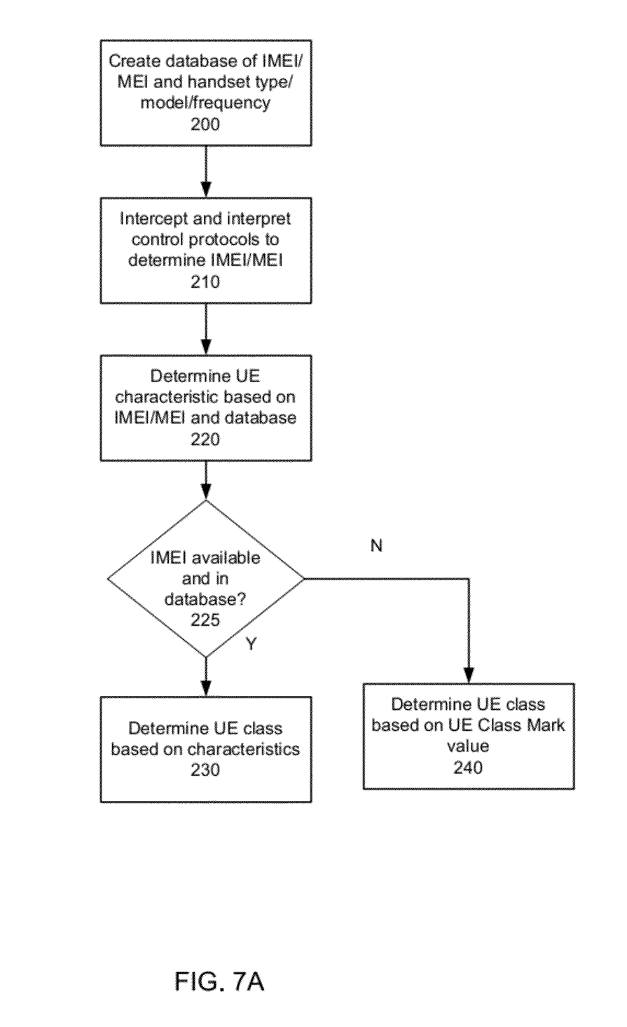

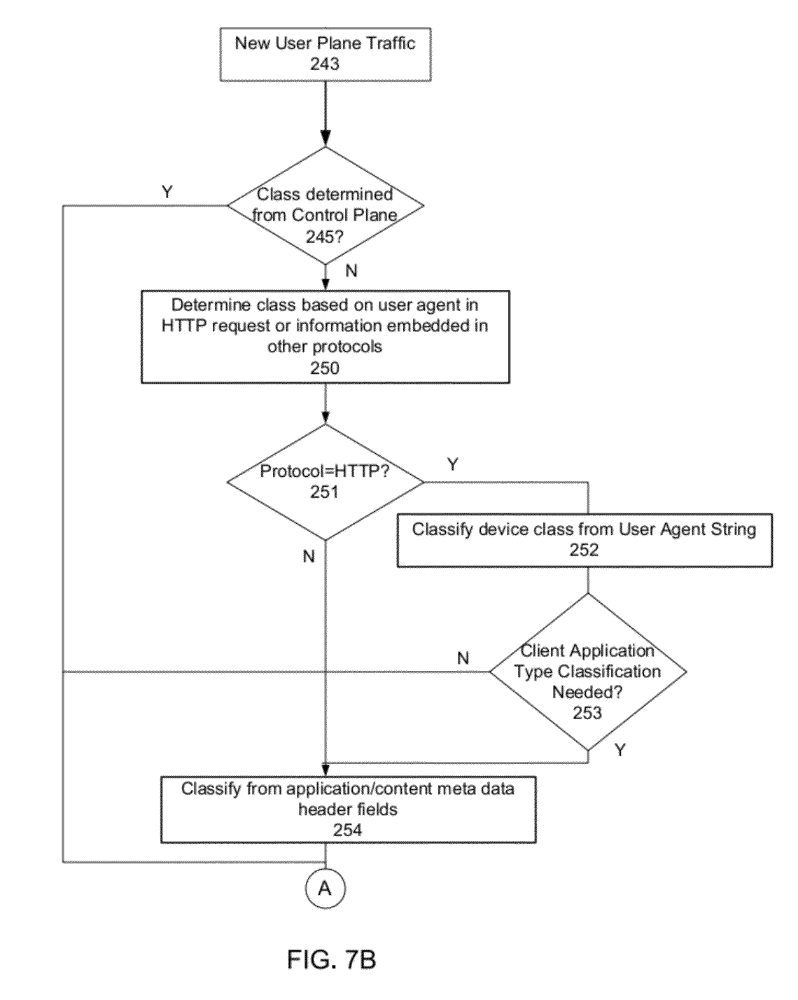

FIG. 2 shows a prior art 3G Network that provides data services and connectivity to Internet to 3G Wireless data users. FIG. 3 shows RAN-C 8 placed between the NodeB (3G Base Transceiver Station) 6, and Radio Network Controller (3G Base Station Controller) 5; the underlying transport on the IuB interface may be ATM or IP. This figure also shows two optional interfaces, one to connect to a local Content Delivery Network Device (CDN) 15, and another, a traffic offload interface (TOI) that connects to operator's IP network or to Internet. With these additional interfaces, the RAN-C 8 has multiple interfaces to the core network. Throughout this disclosure, the terms “RAN-Cache”, “RAN-C” and “RANG” are used to denote a device which can be used as a cache device within the RAN. FIG. 4 shows the RAN-C 8 placed between the RNC 5 and SGSN 4 on the IuPS interface intercepting IuPS Control Plane and User plane protocols in the Packet Switched domain; the underlying transport on the IuPS interface may be ATM or IP. FIG. 5 shows the RAN-C 8 placed between SGSN 4 and GGSN 3 on the Gn interface. FIG. 6 shows the RAN-C 8 placed on the S1 interface between the eNB 6 and ServingGW/MME 11 in the 4G (Long Term Evolution Architecture). Additional details can be found in the aforementioned co-pending U.S Patent Publication No. 2010/0034089.

As stated above, FIGS. 3,4 and 5 illustrate possible locations where a RAN-C 8 may be deployed within the RAN. When these RAN Caches are deployed, the devices are used to cache frequently used content, examine the incoming client requests and, if the requested object (such as, for example, a URL request within HTTP GET or PUT Requests) is found locally in the cache, the RAN Cache 9 delivers content to the client device 7. The device may further identify the delivered content based on the User and Device attributes, such as device identification (International Mobile Equipment Identifier or device type) obtained by interpreting a plurality of control plane and user plane protocols, such as RANAP in UMTS/3G network when placed on the IuPS interface as in FIG. 3, or on S1 interface as in FIG. 5, and HTTP Protocol in user plane. It should be understood, that user device type identification may include further application level identification that the client application propagates to the server. For example, information such as application version, application extensions (such as HD Player vs. SD player) and differentiated caching/content optimizations are natural extensions of the present invention.

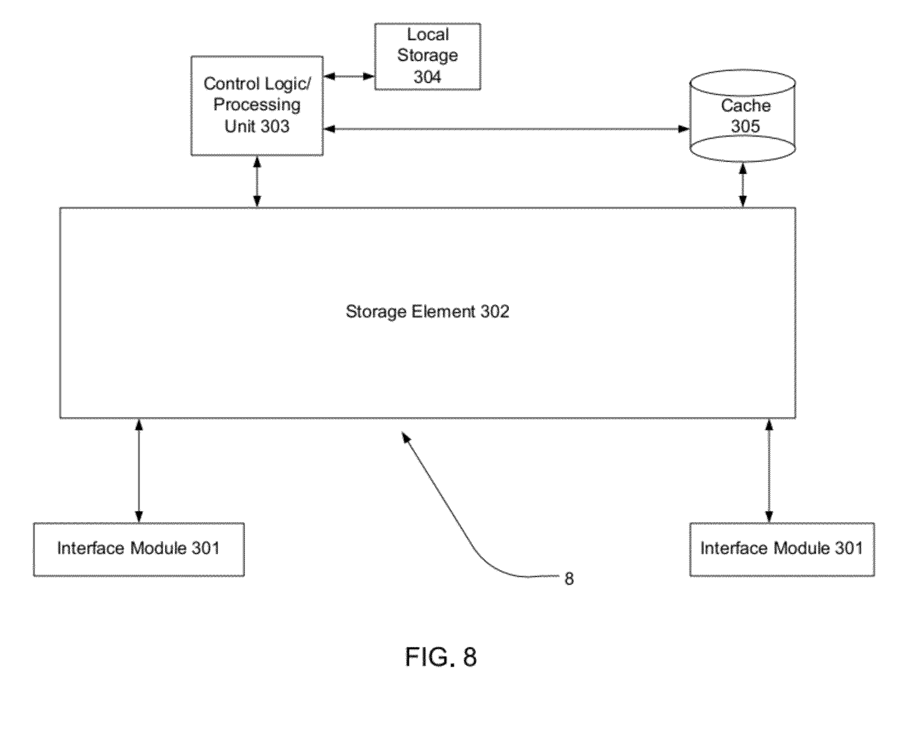

FIG. 8 shows a representative block diagram of the RANC. The RANC 8 has two interface modules 301, each of which is adapted to implement the hardware signaling required for the choice interface and the associated software protocol. This interface protocol may be IuB, IuPS or Gn, as shown in FIGS. 3-5. Each interface module 301 is adapted to receive and transmit on the selected interface. Additionally, received data is placed into a storage element 302, typically a semiconductor storage element such as a RAM, DRAM or an equivalent technology. The movement of data from the interface module to the memory 302 and vice versa may be accomplished using dedicated hardware, such as a DMA controller. Alternatively, a dedicated data movement processor may be used to handle the actual movement of data through the RANC 8. Once stored within the RANC 8, the information is processed in accordance with the RAN specifications. This may be done using dedicated control logic or a processing unit 303. The control logic/processing unit 303 may have its own local storage element 304, which contains instructions to execute and local status. This storage element may be RAM or DRAM. In addition, at least a portion of this storage element 304 may be non-volatile, such as ROM, FLASH ROM, hard disk, Solid State Disk, or the like. Using known specifications and protocols, the control logic/processing unit 303 parses the received information to understand the packet at each protocol layer. Also included may be a large storage element 305, adapted to hold cached information. In some embodiments, this cache storage may be semiconductor memory, such as RAM or DRAM. In other embodiments, this cache storage may be a rotating media, such as a disk drive or other large storage device. The control logic/processing unit may be physically implemented in a variety of technologies. For example, it may be a general-purpose processor, executing a set of instructions from an internal or external storage device.

In another embodiment, a dedicated hardware device having embedded instructions or state machines may be used to perform the functions described. Throughout this disclosure, the terms “control logic” and “processing unit” are used interchangeably to designate an entity adapted to perform the set of functions described.

The RANC 8 also contains software capable of performing the functions described herein. The software may be written in any suitable programming language and the choice is not limited by this disclosure. Additionally, all applications and software described herein are computer executable instructions that are contained on a computer-readable media. For example, the software and applications may be stored in a read only memory, a rewritable memory, or within an embedded processing unit. The particular computer on which this software executes is application dependent and not limited by the present invention.

While the Figures show the RAN-C as a separate device, it may also become part of an existing component. For example, it may be embedded in an existing component, such as the RNC or SGSN and provide the functionality described above.

As stated above, co-pending U.S Patent Publication No. 2010/0034089 describes the operation of a content aware RAN-Cache by intercepting the Control Plane (CP) and User Plane (UP) Protocols in one or more standard interface protocols such as IuPS protocol interface in 3G/UMTS network. As described in that Publication, the caching device intercepts the UP protocol packets, extracts the user IP traffic from the encapsulated tunnels, identifies application protocols such as HTTP, determines if the requested content is already in cache, and delivers the requested objects to the client if those objects are in its local cache (provided that these objects are cacheable and within the limits of the expiration timer as defined by the application protocol).

The present invention describes the system and method needed to capture the device type, and/or application type in the specific device and use this information in a variety of ways. Examples include controlling which version of a web page (WAP or standard) is delivered to the device, or to creating a partition within the cache specific for a particular class or classes of device, or performing device and/or application specific delivery optimizations based on the device and/or application class.

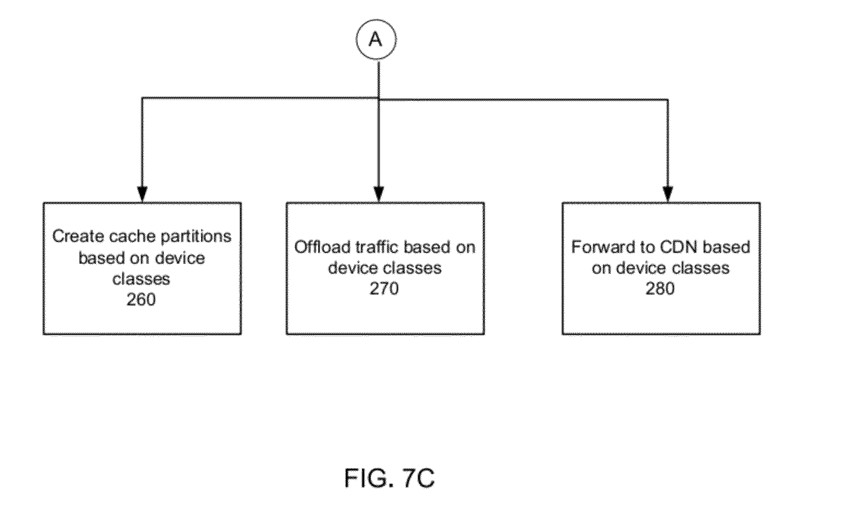

FIGS. 7A, 7B and 7C show flowcharts of the process used to identify the device type. In FIG. 7A, the RAN-C 8 uses information from the control plane to determine the device class. It then associates the control plane with the user plane and upstream and downstream tunnels. In step 200, for identifying mobile device type, the RAN-C 8 maintains an internal TAC (Type Allocation Codes) database that contains mobile device identity (IMEI in 3GPP, and MEI in LTE networks), Handset Brand, Handset Model, supported frequencies etc.

The RAN-C 8 intercepts and interprets the control protocols, such as RANAP in a UMTS Network, when a new UE session is established. Based on this, the RAN-C 8 device extracts the device identity, from either the IMEI, IMEI-SV or MEI fields, as shown in step 210. The RAN-C then searches the TAC database to determine the UE characteristics, such as handset brand, model and other parameters, as shown in step 220. In step 230, the RAN-C 8 may then map the brand and model number to device classes, such as iPhone, Droid, other-SmartPhone, feature phone, laptop interconnect card, etc. The list and number of device classes is arbitrary, based on the device-class based differentiation supported by RAN-C. For example, in one embodiment, the RAN-C 8 may support two cache domains, one for laptop interconnect cards, and another for handset devices. Thus, in this embodiment, simply categorizing brand and model numbers as handsets and laptop interconnect cards may be sufficient.

In other embodiments, to improve QOE for specific products, such as iPhones, the RAN-C 8 may maintain an additional cache domain and service differentiation for iPhones. In this embodiment, the RAN-C may map the brand and model numbers into three device classes. In other embodiments, the RAN-C 8 may further distinguish other devices, such as Droids, iPads, tablets, and other user equipment, based on device brand and model. Such mapping is contained in a database or lookup table within the RAN-C 8, and not present in externally available databases that contains IMEI information.

The device identity (IMEI/MEI) information described in step 210 above may not always be available. This check is performed in step 225. There are various scenarios in which the device identity information may not be available, including:
a. a mobile device entered the scope of a new RAN-C, and the session information that included IMEI is not available, or
b. the specific device is reporting the IMEI as a generic value, or
c. the specific IMEI identifier is not present in the locally configured TAC database (IMEI to Brand/Model table).

In such cases, the RAN-C 8 may approximate the device class from other attributes such as UE Class Mark values, as shown in step 240. UE Class Mark values are described in the 3GPP specification, and are known to those skilled in the art.

In some embodiments, the device class information cannot be identified from the control plane using any of the methods described above. In this case, the RAN-C 8 may use information from the user plane to determine the device type, as shown in FIG. 7B. As new user plane traffic arrives, as shown in step 243, the RAN-C associates the user plane with a control plane. It then determines whether the device has already been classified using control plane information, as shown in step 245. If it has, the RAN-C does not need to perform any additional steps. However, if the RAN-C determines that the device has not yet been classified, it may use information in the HTTP request or other information embedded in other protocols, as shown in step 250. The RAN-C first determines whether the incoming user plane traffic is a HTTP protocol, as shown in step 251. If so, the RAN-C may use the user Agent in HTTP Request headers, as shown in step 252. It is important to note that this information will be available only when the mobile user accesses the network using HTTP Protocol. For example, if the client device opens an FTP connection to a remote server, the FTP protocol does not have a user agent header. Also, even if the user agent header is present, it defines the HTTP client type, and not necessarily the type of network interface that the client device is using to connect to the wireless mobile network. Thus, for example if there are two laptops, one with a 3G Dongle that supports 4 Mbs data rate, and another with a USB dongle that supports 7 Mbs data rate, where both using Internet Explorer 7, the user agent field in the HTTP Requests will be identical and the two interface card types could not be distinguished. Thus, classification based on HTTP User Agent is used only when other more reliable information is not available. Thus, the combination of IMEI/MEI based along with user agent based mapping to device class as described herein identified is superior to using HTTP User agent headers only.

Similar to the user agent header in the HTTP application, other applications may also convey their versions or variations to specific devices. For example, a video player application may convey its version, the device it is running on and other information using client application fields in the corresponding protocols, such as RTMP and HTTP. The RAN-C that is intercepting Control Plane and User Plane Protocols decodes the control plane and some application protocols to determine the method of classifying the user device and/or user application making the request, as shown in step 254.

Using the steps shown in FIGS. 7A and 7B, the RAN-C can identify specific classes of mobile device. The device class identification as determined in FIGS. 7A and 7B is used by the RAN-C for improving QOE for specific classes of mobile devices, and improving overall QOE for a number of users, such as by controlling bandwidth usage by certain classes of device. For example, a small number of users with USB dongles may use the mobile network heavily, thus reducing QOE for a number of other users. Thus, by identifying laptop user sessions and limiting their usage, RAN-C could improve QOE for a number of handset devices. Similarly identifying and prioritizing user sessions from feature phones improves QOE for large number of users, since the number of users with feature phone is much larger than smart phone and laptop users. Thus, the RAN-C can affect QOE by prioritizing certain classes of devices above others, or conversely, by de-prioritizing certain classes of devices, which may consume excessive network resources. While caching and delivering requested content, the device of the present invention may perform differentiated treatment of its own organization (colored caches with different sizes/priorities) for improved QOE, and monetization for promoting certain device and/or applications.

FIG. 7C shows various actions that can be taken based on device class. One possible optimization that RAN-C performs based on the device class is to maintain a cache per device class, as shown in step 260. For example, in one embodiment, a separate cache may be established for all objects for a specific device, such as an iPhone. In another embodiment, a separate cache can be established for specific content types (for example video objects) for that specific device. In other embodiments, a separate cache is established for a specific class of devices. For example, all smart phones, such as Blackberry devices, Droid devices, and other similar devices, may be assigned to a single device class and share a cache. Of course, a separate cache may be established for additional or different device classes.

Content caching mechanisms use caching and replacement policies for cacheable objects based on frequency of use, time of use, and other parameters measured for a number of users. In mobile networks, a small number of users, typically laptop users with high speed 3G/HSDPA/HSDPA+ dongles consume very large amounts of network bandwidth. Such large, frequent accesses by a small number of users populate the caches heavily with objects/content accessed by those users. Partitioning the cache per device class overcomes this problem by preserving the content accessed from those classes of devices. Also, devices, such as iPhones, may have customized applications for specific site/content type accesses (for example, the iPhone YouTube application). When new device types and applications are launched, maintaining and managing delivery based on device class improves the QOE for that device class.

In some embodiments, the device class may be specific to the device or type of device. In other embodiments, the device class may be further categorized according to the application being executed on the device. For example, it may be possible that different classes exist for an iPhone running a YouTube application and an iPhone running a Safari browser application. Thus, the term, device class may include attributes of the device itself, or attributes related to the applications being executed on the device.

For maintaining caches per device class as described above, the device class identified in FIGS. 7A-C is stored in the user-session context maintained in RAN-C 8. The cache is logically segmented to multiple partitions. For example, in one embodiment, there is a default partition for all devices other than the iPhone, and a second partition specifically for the iPhone. Of course, additional or different partitions may be created based on other device classes. As objects are fetched for requests from the iPhone, the objects are stored in the iPhone partition. For each partition, the RAN-C 8 may maintain different caching, replacement, differing size limits for portions stored in RAM vs. secondary storage. In addition, specific devices/applications may have unique access patterns. For example, iPhone YouTube accesses use byte ranges in HTTP protocol. Thus, identifying and associating objects and content with device classes facilitates optimized content delivery.

The determination of device classes also allows other functionality to be implemented in the RAN. For example, the 3GPP Standards Organization is currently defining Selective IP Traffic offload by which portion of mobile traffic is off-loaded from mobile core-network to an alternate interface that connects to an alternate IP Network. This is described in 3GPP 23.829 V1.1.0, Technical Report, Local IP Access and Selected IP Traffic Offload (Release 10), the contents of which are incorporated herein by reference in their entirety.

The present invention extends the offload mechanism in a content caching device (RAN-C), by directing all accesses from certain device classes to the offload interface, or by using the offload interface for cache-miss operations based on device class, as shown in step 270. The default interface for data access through the core is the corresponding mobile core network as described in Co-pending Patent Publication No. 2010/0034089. In one embodiment, the RAN-C 8 may over-ride the default for certain device classes. In one example, all user sessions from a class of devices, such as laptop interconnect cards, could be re-directed to Traffic Offload Interface, thereby bypassing the content caching/proxy entirely. In another embodiment, any cache-miss operations from a class of devices, such as laptops, could be directed to the offload interface. In another embodiment, only HTTP traffic for laptop interconnect cards is re-directed to the Traffic Offload Interface. The choice of which traffic to offload may be based on device class, the type of content requested, and the result of the cache operation.

In another embodiment of the current invention, traffic is forwarded from selected device classes to a locally connected CDN (Content Delivery Network) device 15, as shown in step 280. A CDN device 15 operates with user IP packets and does not process mobile user plane or control plane protocols. The RAN-C 8, as deployed in any of the wireless mobile networks shown in FIGS. 3-6, interfaces with RAN devices, and identifies user sessions and the associated device classes. Based on the determined device class, the RAN-C selectively forwards traffic to the locally connected CDN. Such forwarding may be for all traffic from a selected device class, thereby bypassing the content cache/proxy within the RAN-C 8. In another embodiment, the CDN interface is used for cache-miss operations, as described above. Using this interface selection and forwarding to the local CDN device facilitates allowing the CDN device to be closer to the mobile edge, where the RAN-C is deployed in the RAN close to BTS (NodeB/eNodeB) 6, and RNC 5.

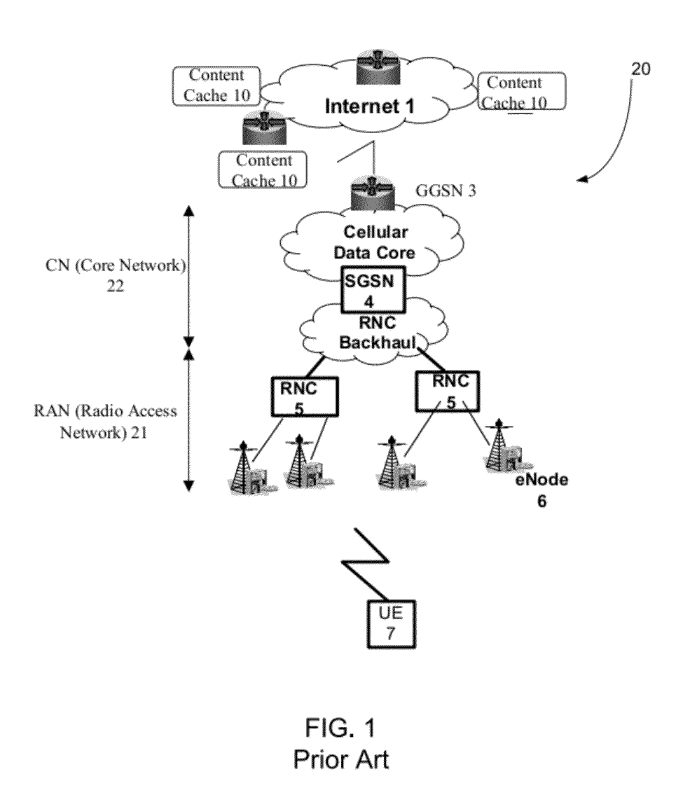

In the prior art technologies as shown in FIG. 1, CDN devices are deployed above the GGSN in central locations, whereas devices in the RAN are closer to the end user. Thus, the scope of an RNC 5 and the corresponding RAN-C 8 are close to the vicinity of the mobile users accessing the mobile operators' network. Thus, the content delivered from the local CDN device or through the offload interface could be different from the content that the RAN-C 8 receives from the default mobile core network (SGSN/GGSN, S-GW/PDN-GW). This mechanism implicitly assists the CDN device in selecting content, advertisements, etc., more relevant the coverage area of the RAN-C 8. In addition, this reduces the transport latency for content delivered by the CDN similar to the cached content delivered by the RAN-C 8.

In a further embodiment, the caching control and forwarding selection decisions described in steps 260, 270 and 280, which are based on device class, could be further enhanced. One such enhancement is the inclusion of the user's service plan in the selection. This may be achieved by the RAN-C by registering with the Operator's Service plane, such as a RADIUS server, identifying the user's service plan type, and storing the plan-type along with the UE device type when user plane session is established. Subsequently, when user plane packets are received from UE on the corresponding user plane session, RAN-C 8 performs caching and destination selection functions based on the limitations of the service plan. For example, a higher-end plan may utilize the cache, the traffic offload interface or the CDN to speed access to users who pay more for their service. Conversely, lower cost plans may not be cached, or may never be offloaded.

The content delivery and core-interface selection described in steps 260, 270 and 280 may be for the entire user plane traffic (TCP, UDP, DNS, HTTP etc.), or only portions of the traffic, such as HTTP only. In other words, the RAN-C 8 may forward only HTTP traffic for iPhones to the local CDN. In another embodiment, the RAN-C 8 may forward only DNS and HTTP traffic to the local CDN.

The above description describes implementing certain functionality based on the type of device that the user has. However, the above described functionality can also be implemented based on other criteria. For example, the use of separate cache partitions, traffic offload, and CDN delivery may be based solely on the user's service plan. In some embodiments, those users having a premium plan may have additional functionality.

In another embodiment, these features may be based on the client application being used by the user. For example, certain applications may have a different monetization scheme than the traditional “per byte downloaded” plan. One such example usage is that the RAN-C may detect that an application is a DRM compliant video player, such as a NetFlix Player. The operator may have a different monetization scheme for this application. For example, there may be a fixed fee per movie, regardless of byte count. Therefore, the RAN-C may make the decision to offload the traffic for this tunnel, as it is not important to the operator that the bytes be counted as they pass through the core network. Other applications may also have similar monetization schemes that make them ideal candidates to be offloaded to the TOI interface rather than forwarding through the SGSN/GGSN. Similarly, these applications may be likely candidates for caching, as the downloaded byte count is not important.

In another embodiment of the current invention, the locally determined information such as device class, UE capabilities, or location information inferred by interpreting per UE control plane protocols, is propagated by using extension headers in the user plane protocols, such as HTTP. The location information inferred by the RAN-C by interpreting the per user Control Plane traffic need to be distinguished by the GEO codes information that certain mobile devices with GPS propagate to the applications. The location information inferred by the RAN-C is not dependent on the mobile device capabilities (such as GPS). The placement of RAN-C in wireless mobile network in the RAN inherently makes it local to the RAN that it is placed. Such location information is coarse, for example, a city area or group of BTS locations covered by the RNC. Additionally, by interpreting the “Initial UE Message” (RANAP protocol) in the control plane, RAN-C identifies the Node-B/eNodeB that the mobile device is associated with. From this message, RAN-C infers the sector or location area or Service Area (LAI/SAI) that the mobile device is located. Thus, this information elements are less granular than the GEO co-ordinates, but more granular than centrally located GGSNs. Additionally, the present invention identifies that while the mobile device or an application running on the mobile device may obtain GEO-Coordinates, that information is not directly available to remote applications. Furthermore, enabling GPS hardware to get GEO-code information consumes significant handset battery power. Thus, the present invention uses the UE's registration with the network (Sector) as coarse location information.

In this embodiment, the UE requests identified by de-encapsulating the user plane protocol, are enhanced with extension headers and forwarded to the default CN interface after re-encapsulating to the original protocols, or forwarded to the local CDN device, or to the offload network as in FIGS. 3-6 without re-encapsulating to the mobile protocol.

While the concept of header enrichment to http request headers, and adding extension headers to other protocols may exist in the prior art, the present invention does more than simply add an extension header. Rather, the present invention extracts the information from other mobile control plane, user plane, and service plane protocols, converts to a class or other short attribute, and adds locally known/configured information such as the location of the RAN-C (for example the street address configured in RAN-C) or by mapping Sector ID, Location Area ID (LAI), or Service Area ID (SAI), or Tracking Area ID (TAI) of a mobile user to approximate geographical location.

The nature of the locally included extension headers is dependent on the corresponding application protocol they are added to. For example, for http requests, the information is added using header enrichment. For DNS requests, the information is added using vendor unique extensions.

The information added by RAN-C may include: mobile device class, handset brand, and model, RAN-C location, inferred geographical location of the mobile user, Radio Access Technology type, Subscriber Service plan type, inferred QOS parameters to the user device, inferred priority of the user request, and other characteristics.

The added information described above assists the CDN in tailoring the responses with most relevant content, per the current mobile device, Radio Conditions, type of user, service plan, and location.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

What is claimed is:

1. A method of classifying a mobile device as belonging to a particular device class by a transparent network device placed in a wireless mobile network as an inline device adapted to intercept a plurality of control plane and user plane protocols, where said mobile network services a plurality of users, and wherein said network comprises a plurality of components, said method comprising:
a. inserting said transparent network device in said network, said device comprising a storage element, and control logic;
b. using said control logic in said device to interpret a communication from a first component to a second component, so as to determine the user session and the content of said communication, wherein said communication comprises a plurality of protocol layers; wherein said protocol interpretation includes extracting device identification information from said control plane for a user device;
c. maintaining within said network device a database of device identification information, a corresponding device class, and specific parameters for said device class; and
d. using said extracted device identification information to map said user device to a device class based on said database of device identities.

2. The method of claim 1, further comprising using other attributes from said control plane to map said user device to a device class.

3. The method of claim 2, wherein said other attributes are used when said device identification information does not map to a device class in said database.

4. The method of claim 1, further comprising interpreting user plane HTTP protocols, identifying the User Agent Header, and mapping said user device to a device class based on said user agent.

5. The method of claim 4, wherein said interpretation is performed when said device identification information does not map to a specific device class.

6. The method of claim 1, further comprising interpreting application fields contained within an application protocol, and mapping said user device to a device class based on said application fields.

7. A method of managing cached information in RAN Cache device, comprising determining device classes, using the method of claim 1, and maintaining separate caches for each device class.

8. A method of selecting a forwarding interface in a RAN-cache device wherein said device is placed in a mobile wireless network with a plurality of logical interfaces toward the core network and/or internet, based on device class derived using at least one of a plurality of methods.

9. The method of claim 8, wherein said methods are selected from the group consisting of deriving device class information from the device identity, deriving device class information from the UE capabilities from said control plane, deriving device class information from a local database that maps device identities to device classes, deriving device class information from user requests, and deriving device class information from application fields.

10. The method of claim 8, wherein said plurality of logical interfaces is selected from an offload interface, the mobile core network, and a local CDN.

11. A method of communicating information obtained using the method of claim 1, comprising adding extension headers to the mobile user requests in the user plane and forwarding said requests.

12. The method of claim 11, wherein said requests are forwarded to the core network, an offload network, or to a local CDN.

13. The method of claim 11, wherein said extension header comprises data selected from the group consisting of information derived from said device identity, information derived from UE capabilities from said control plane, information from a local database that maps device identities to device classes, information from user requests, information from application fields and location information.

14. A method of classifying a mobile device by a transparent network device placed in a wireless mobile network as an inline device adapted to intercept a plurality of control plane and user plane protocols, where said mobile network services a plurality of users, and wherein said network comprises a plurality of components, said method comprising:
a. inserting said transparent network device in said network, said device comprising a storage element, and control logic;
b. using said control logic in said device to interpret a communication from a first component to a second component, so as to determine the user session and the content of said communication, wherein said communication comprises a plurality of protocol layers; wherein said protocol interpretation includes extracting information from a client application executed on a user device;
c. determining, based on said extracted information, characteristics of said user device or said client application;
d. routing traffic through said network based on said determined characteristics.

15. The method of claim 14, wherein said traffic is routed to a traffic offload interface.

16. The method of claim 14, wherein said traffic is routed to a CDN.

17. The method of claim 14, wherein said extracted information is selected from the group consisting of device type and monetization scheme.
